(19) United States
(12) Patent Application Publication
(10) Pub. No.: US 2024/0343006 A1
(43) Pub. Date: Oct. 17, 2024

(54) LIGHT GUIDE AND METHOD FOR ITS PRODUCTION

(71) Applicant: MERCEDES-BENZ GROUP AG, Stuttgart (DE)

(72) Inventors: Jan Theo Gerd SIEMEN, Bocholt (DE); Michael LAHRES, Neu-Ulm - Burlafingen (DE); Christian Frank Ruprecht GÖPPNER, Nürnberg (DE); Alexander MÜHLEISEN, Bretzfeld (DE)

(21) Appl. No.: 18/292,389

(22) PCT Filed: Jun. 23, 2022
(86) PCT No.: PCT/EP2022/067216

§ 371 Date: Jan. 26, 2024

(30) Foreign Application Priority Data
Jul. 27, 2021 (DE) 10 2021 003 866.5

(51) Int. Cl. B29D 11/00; B33Y 10/00; B33Y 40/20; B33Y 80/00

(52) U.S. Cl. CPC B29D 11/00663; B33Y 40/20; B33Y 80/00; B33Y 10/00

(57) ABSTRACT

A light guide is produced using a blank generated by additive manufacture. The blank is then reworked with at least one machining tool. The blank is exclusively reworked in at least one region, which is not provided as a light decoupling point.

### BACKGROUND AND SUMMARY OF THE INVENTION

Exemplary embodiments of the invention relate to a method for producing a light guide and to a light guide.

As described in DE 10 2019 111 620 A1, a device and a method for additive manufacture of a three-dimensional object from at least one starting material are known. The device has a control device, which is equipped to calculate, based on 3D data of the object, print webs for layers of the starting material to be removed. The device further has an actuator device movable in several degrees of freedom, having an end effector and an extruder or printhead fixed to the end effector, wherein the actuator device and the extruder or printhead are communicatively connected to the control device, in order, depending on the calculated print webs, to remove the starting material layer by layer from the extruder or printhead according to the specification of the control device. The actuator device is movable in at least four degrees of freedom, wherein the control device calculates the print webs on the basis of a simulation model, while considering web spacings, the alignment, and/or the course of the layers to be removed in order to determine component properties of the object.

DE 10 2014 112 470 A1 describes a trim part for a motor vehicle with a glowing visible side. The trim part comprises a support, a composite film, and a light source. The composite film is arranged on the support, and forms the visible side of the trim part. The composite film has a light guidance layer, a dispersal layer, and two paint layers, such that light beams generated by the light source can be coupled into the composite film, and the visible side of the trim part is lit over its surface using the composite film.

An optical element and a lighting system using this element are known from WO 2017/029281 A1. The optical element comprises a light guide having a front side, a rear side, and a surrounding edge and a light-dispersing 3D structure, which is arranged directly on the front side of the light guide. The light-dispersing 3D structure is arranged such that it partially covers the front side of the light guide. The light-dispersing 3D structure is arranged such that it disperses light interacting with it such that at least a part of the dispersed light exits the light guide on the rear side of the light guide.

GB 2580883 A describes a lighting device comprising a light guide produced by means of 3D printing and a lighting means. The light guide has several portions positioned to influence the light incident thereon by reflecting, absorbing, and/or dispersing the light. The device has openings for receiving the lighting means. The lighting means is located in a separate housing adapted to engage with an edge of the light guide. The lighting means contains one or more LEDs. The light guide contains a base layer, which can reflect or disperse light.

US 2008/0266863 A1 discloses an ultra-thin lighting element comprising at least one light source. A light guide element comprises a light guide layer, which comprises a plurality of discrete, fine optical surface relief structures on at least one portion of at least one surface. Each surface relief structure comprises fundamental structural features, the height of which is approximately 10 micrometers or less, and each lateral dimension of which is approximately 10 micrometers or less. The number, arrangement, and size of each surface relief structure and the height and lateral dimensions of the structural features of the surface relief structures are varied, in order to provide a desired degree of decoupling modulation of light coupled into the light guide element.

Exemplary embodiments of the invention are directed to a method for producing a light guide that is improved in relation to the prior art and a light guide that is improved in relation to the prior art.

In a method according to the invention for producing a light guide, in particular for a vehicle, in particular for a vehicle component, a blank of the light guide is generated by additive manufacture, and the blank is then reworked with at least one machining tool. This kind of reworking is also described as machining, turning, or material-removing or mechanical reworking.

According to the invention, the blank is exclusively machined in at least one region, which is not provided as a light decoupling point. This region extends, in particular, over an entire surface of the blank, in particular, at least over an entire peripheral surface, i.e., lateral surface of the blank, with the exception of a surface of the at least one or respective light decoupling point. In other words, the blank is reworked everywhere where no light decoupling point is provided, and the blank is not reworked where a light decoupling point or a respective light decoupling point is provided.

A light guide according to the invention, in particular for a vehicle, in particular for a vehicle component, is produced with this method. According to the invention, it has at least one reworked region and at least one provided light decoupling point, which has a surface exclusively generated by additive manufacturing. The reworked region extends, in particular, over an entire surface of the light guide, in particular, at least over an entire peripheral surface, i.e., lateral surface of the light guide, with the exception of a surface of the at least one or respective light decoupling point.

The solution according to the invention in particular makes it possible to generate local roughness differences on the surface of such an additively generated light guide by limiting the reworking. This limitation is achieved, as is explained in more detail in the following, in particular, by one or more predetermined geometric shapings of the blank, which are generated by additive manufacturing.

The functionality of the light guide produced by means of the solution according to the invention for guiding light coupled into the light guide within the light guide is based on the principle of a total internal reflection. In order to fulfil this principle, a sufficiently flat surface must be present on the light guide, which cannot be generate by additive manufacturing, however. The blank produced by additive manufacturing is thus then reworked in the manner described, whereby the surface of the blank is smoothed such that total internal reflection takes place.

Directly after the additive manufacture, the blank of the light guide has a surface that is so rough that light coupled into the light guide is here diffusely dispersed, and consequently does not remain in the light guide. On the reworked surface, however, which is sufficiently smooth, no or significantly less diffuse dispersal takes place, and instead the light is specular-reflected, because the condition for total internal reflection, i.e., the critical angle of total internal reflection, can be maintained by a sufficiently smooth surface. The region of the light guide reworked in the manner described thus correspondingly has a smooth surface, and no light is decoupled, while the non-reworked at least one or respective light decoupling point of the light guide retains a rough surface generated by the additive manufacturing, on which the light coupled into the light guide is decoupled from the light guide via diffuse dispersal.

The solution according to the invention thus makes it possible to produce light guides, in particular easily, via additive manufacturing. Due to this manufacturing without tools, very high costs connected with the conventional production of the light guides by injection molding and complex injection molding tools used in the process are dispensed with. The solution according to the invention is thus significantly cheaper, whereby series production with a small number of parts or single-piece manufacturing can also be achieved in an economical manner.

The solution according to the invention additionally offers a high potential for individualization due to manufacturing costs which are independent of the number of parts.

Via the solution according to the invention, complex light guide geometries can be produced very easily, which are impossible or only possible with very high complexity by means of injection molding, for example bionic structures, undercuts, and other complex geometries.

The solution according to the invention, in particular the additive manufacturing used, further makes an increased functional integration possible via multi-material structures, for example via the integration of the light guide into a component, for example into a trim part, in particular by generating the blank of the light guide on the component or together with the component by additive manufacturing. Thus, for example, it is possible to reduce the installation space required for the component with the light guide. Further design freedom is thus also enabled, which, for example, enables further lighting innovations, in particular in relation to the interior light of the vehicle.

Due to a multi-material capability of the additive manufacturing, light guides with colored components in the structure can also be implemented, in order thus to enable predetermined color gradients, for example.

In order to decouple the light, in the solution described, there is no need for complex geometric structures having low shape tolerances, in particular in the form of prisms, at the at least one or respective decoupling point, whereby a corresponding complexity and costs resulting from the latter are saved.

In the solution according to the invention, reworking methods can be used for the reworking, in which edges are rounded. In the solution according to the invention, such edge rounding is not an issue, unlike in the prior art, in which light guide production requires complex geometric structures having low shape tolerances, which would be damaged by such a reworking method.

In relation to the prisms generated in the prior art for decoupling light, a more homogeneous light dispersal is possible due to the solution according to the invention, because the light dispersal takes place over a fine roughness of the non-reworked surface of the light guide generated by additive manufacturing, at the at least one or respective light decoupling point. The light is thus dispersed more finely, and distributed less crudely.

According to the invention, a recess is generated by the additive manufacture of the blank on at least one predetermined portion of the blank, on which the at least one light decoupling point of the light guide is provided, or on the respective predetermined portion of the blank on which the respective light decoupling point of the light guide is provided, such that, and at least one machining tool is used to rework the blank, the machining tool being designed such that at least one surface portion of the blank in the recess cannot be reached with the at least one machining tool used to rework the blank. For example, the recess is generated by the additive manufacture of the blank on the at least one predetermined portion of the blank, on which the at least one light decoupling point of the light guide is provided, or on the respective predetermined portion of the blank on which the respective light decoupling point of the light guide is provided, such that, and at least one machining tool is, for example, used to rework the blank, the tool being designed such that an opening of the at least one recess is smaller than a size of the at least one machining tool used to rework the blank, in particular such that a length and/or a width and/or a diameter and/or a clear width of the opening of the recess is smaller than a length and/or a width and/or a diameter and/or a surface area of the at least one machining tool used to rework the blank, and/or such that a depth of the at least one recess is greater than a height of the at least one machining tool used to rework the blank.

The surface, generated exclusively via additive manufacturing, of the at least one provided light decoupling point or of the respectively provided light decoupling point of the light guide is thus located according to the invention in the recess generated by the additive manufacturing.

The solution described thus makes it particularly easily possible to rework the blank exclusively in the region that is not provided as a light decoupling point, because it is ensured by the design of the recess and the tool used for reworking that the surface of the blank cannot be reworked in the at least one or respective region provided as a light decoupling point by means of the tool used. No additional safety measures must thus be taken for the reworking in order to ensure that the surface of the blank is not reworked on the provided at least one or respective light decoupling point. The described solution thus, in particular, makes it possible to generate local roughness differences on the surface of the additively generated light guide via the limitation of the working achieved via one or more predetermined geometric shapings of the blank in the form of recesses.

In a possible embodiment of the method, the blank is reworked via grinding, in particular vibration grinding and/or polishing. The at least one machining tool used for reworking for this process is thus designed as at least one grinding body and/or polishing body or comprises at least one such grinding body and/or polishing body.

The at least one reworked region is thus reworked on the light guide according to the invention via grinding and/or polishing.

In such reworking methods, for example vibration grinding, smoothing is achieved via a relative movement between the tool, in particular the grinding body and/or polishing body, and the workpiece, here the blank of the light guide. In the method described here, in the manner described above, only the region of the surface of the workpiece geometry of the blank is smoothed on which the tool, in particular the grinding body and/or polishing body, can also correspondingly slide and slide past, i.e., along which the grinding body and/or polishing body can slide. As this is impossible at the provided at least one or respective light decoupling point in the manner described above, the surface of the blank of the light guide is thus not reworked there.

In the embodiment described above, the technical solution thus consists in that the additively manufactured blank of the light guide has a geometry leading the at least one tool used for reworking, for example the grinding body and/or polishing body, to be unable to act, or to be able to act only under certain conditions, at at least one predetermined point, specifically the at least one provided light decoupling point, or at several such points on the surface of the blank of the light guide, while the blank is being reworked, and thus allows the light decoupling along the light guide to be able to be adjusted in a targeted manner via the geometry and the local variation of the roughness of the surface specified above, which was generated by the additive manufacturing.

The at least one or the respective recess can, for example, be designed as a blind hole, groove, incision, or other recess. As already specified, the recess is generated by the additive manufacture of the blank. The opening of the at least one or respective recess is advantageously smaller than the at least one tool used for reworking, in particular the grinding body and/or polishing body. The surface of the blank at the respective point, which is provided as a light decoupling point, is not reworked, while advantageously the remaining surface of the blank is reworked, in particular ground smooth and/or polished. The rough part of the surface then serves as a decoupling structure, and thus forms the light decoupling point of the light guide, and total internal reflection takes place on the remaining surface of the light guide.

Due to the additive manufacture of the blank, the recess or the respective recess is, for example, generated with constant dimensions or with at least one dimension that changes over the course of the recess, for example with a changing depth and/or width and/or with a changing diameter and/or a changing clear width. The course of the recess can be aligned in the length direction and/or width direction and/or depth direction and/or peripheral direction of the blank, and thus also of the light guide.

On the light guide, the recess or the respective recess correspondingly has constant dimensions, for example, or at least one dimension which changes over the recess course.

To form a structure of the respective recess and a structure of the respective light decoupling point, many variants are possible; in addition to simple, straight recesses, many further geometries are also considered.

The decoupling structure generated in this manner of the light decoupling point or several light decoupling points can, in particular, be designed in a graduated manner without further complexity. For example, an undesired, uneven emission of the light guide, which is already present due to volume dispersal or the like without a decoupling structure, can be homogenized in this manner via a gradient that is inverse to this uneven emission. As an alternative, or in addition to homogenization, a graduated decoupling structure can also be used to generate a predetermined brightness course, for example in order to particularly showcase predetermined regions of the component designed as a decorative part and comprising the light guide. The graduated design of the light decoupling point or several light decoupling points is, in particular, achieved by a corresponding design of the recess or of several recesses, in particular in the manner described above by the at least one dimension which varies over the course of the recess or several or all dimensions of the recess which vary over the course of the recess, and/or by several recesses with dimensions which differ from one another.

By additive manufacture, it is additionally possible to also orientate the surface of the blank in a predetermined manner, i.e., to align it in a predetermined manner, in particular deviating from a surrounding surface, in particular reworked surface, of the light guide, at the at least one or respective light decoupling point, i.e., in the region that is not reworked, and in which light is thus decoupled due to the maintained roughness produced by additive manufacturing. A direction of the decoupled light can thus also be adjusted, in particular if the roughness is such that specular components are also present in addition to a diffuse light decoupling.

The additive manufacturing is also referred to as 3D printing. The blank of the light guide is, for example, additively manufactured by photopolymer jetting, stereo lithography, or a light projection method, in particular DLP (Digital Light Processing). A material from which the blank is generated is advantageously irradiated in a targeted manner, and thus hardened in a targeted manner, with the light projection method, in particular DLP.

The light guide can, for example, already be embedded in another component, in particular in a vehicle component, while the light guide is being produced, i.e., the blank of the light guide is already generated by additive manufacturing on the other component, in particular vehicle component. As an alternative, it can, for example, be provided that the light guide is only embedded into the other component, in particular vehicle component, i.e., is arranged thereon or therein, once it has already been completely produced in the manner described above.

It can thus be provided that a component, in particular a vehicle component, has at least one such light guide. The at least one light guide is arranged on and/or in this component, in particular a vehicle component.

Exemplary embodiments of the invention are explained in more detail in the following with reference to the drawings.

### BRIEF DESCRIPTION OF THE DRAWING FIGURES

Here:

FIG. 1 schematically shows a longitudinal section of a blank of a light guide,

FIG. 2 schematically shows the blank from FIG. 1 in an aerial view,

FIG. 3 schematically shows a reworking of the blank depicted in the longitudinal section from FIGS. 1 and 2,

FIG. 4 schematically shows the reworking according to FIG. 3 in an aerial view,

FIG. 5 schematically shows a longitudinal section of the completely produced light guide during the light guidance,

FIG. 6 schematically shows the completely produced light guide during the light guidance in an aerial view,

FIG. 7 schematically shows a longitudinal section of a further embodiment of the light guide,

FIG. 8 schematically shows the light guide from FIG. 7 in an aerial view,

FIG. 9 schematically shows a longitudinal section of a further embodiment of the light guide,

FIG. 10 schematically shows the light guide from FIG. 9 in an aerial view,

FIG. 11 schematically shows a longitudinal section of a further embodiment of the light guide,

FIG. 12 schematically shows the light guide from FIG. 11 in an aerial view,

FIG. 13 schematically shows a longitudinal section of a further embodiment of the light guide,

FIG. 14 schematically shows the light guide from FIG. 13 in an aerial view,

FIG. 15 schematically shows a longitudinal section of a further embodiment of the light guide,

FIG. 16 schematically shows the light guide from FIG. 15 in an aerial view,

FIG. 17 schematically shows a longitudinal section of a further embodiment of the light guide,

FIG. 18 schematically shows the light guide from FIG. 17 in an aerial view,

FIG. 19 schematically shows a longitudinal section of a further embodiment of the light guide, and

FIG. 20 schematically shows the light guide from FIG. 19 in an aerial view.

Parts corresponding to one another are provided with the same reference numerals in all figures.

### DETAILED DESCRIPTION

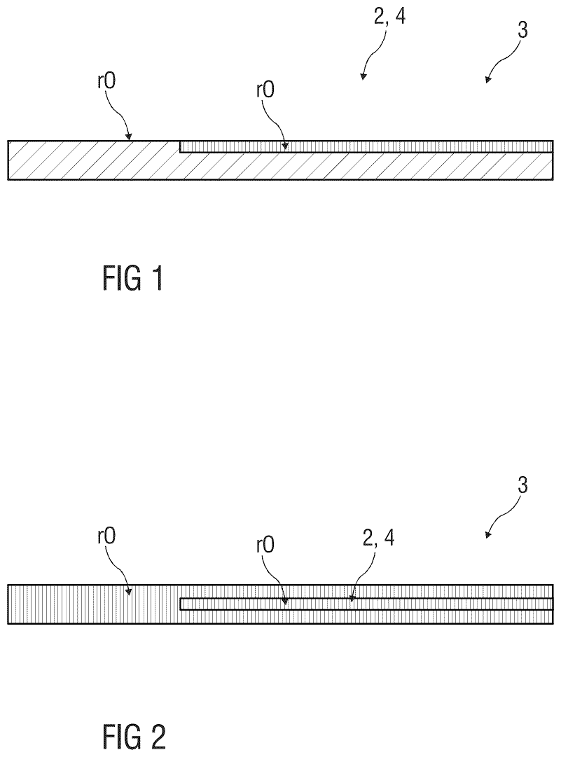

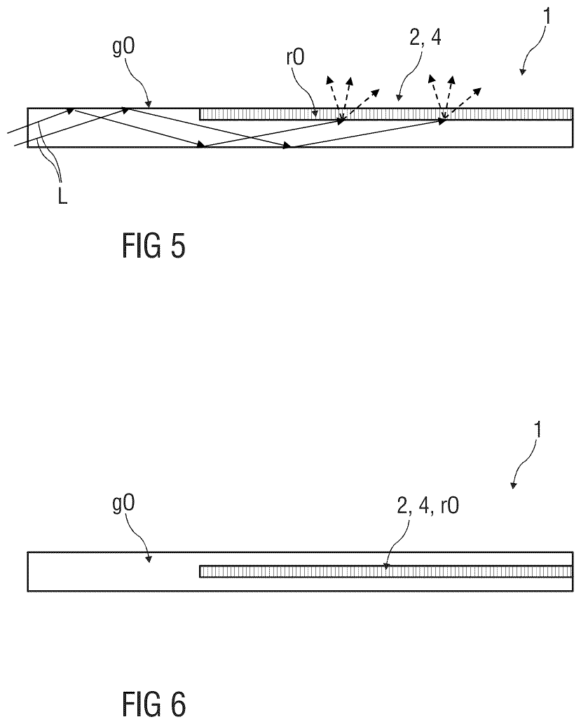

In the following, a method for producing a light guide 1 is described with reference to FIGS. 1 to 20 and, in particular in FIGS. 5 to 20, embodiments of light guides 1 produced by means of this method are described. The light guide 1 is in particular a transparent or at least translucent component for light guidance.

The light guide 1 functions according to the principle of total internal reflection, and can thus guide light L, which is coupled into the light guide 1, along a predetermined geometry, as shown in FIG. 5. The geometry is, for example, predetermined by a component (not depicted here) on which the light guide 1 is arranged. In addition to light guidance, however, a targeted light decoupling should also take place in a surrounding structure, mostly at defined points of the component, as also shown in FIG. 5. The light guide 1 thus advantageously has at least one light decoupling point 2, at which the light L is decoupled again, diffusely in the example according to FIG. 5.

For example, in order to implement certain internal lighting concepts for vehicles, light guides produced by injection molding have previously frequently been resorted to. Prisms are then provided for light decoupling, which lead the critical angle of the total internal reflection to be interrupted in a targeted manner and light L to be decoupled.

In the solution described in the following, another approach to light decoupling and a different production of the light guide 1 associated therewith is described. This solution can, for example, replace previously used solutions, or supplement them in a complementary manner, and can in particular be used if a decoupling via prisms can only be implemented with difficulty.

In the different production of the light guide 1 via an additive manufacture, this is in particular the case, because this additive manufacturing requires a reworking of the surface of the light guide 1 in order to enable the total internal reflection. Via this downstream reworking, component edges are rounded, such that there are restrictions on the prism geometries that can be implemented.

The method for decoupling light described in the following is thus in particular suitable for additively generated light guides 1. The method can be used to locally set the points at which light L is decoupled, i.e., a respective light decoupling point 2 can be predetermined and can be generated via the production of the light guide 1 described in the following.

With the solution described in the following, it is thus possible to decouple light L in a targeted manner at a respectively provided light decoupling point 2 in transparent or at least translucent light guides 1, which are in particular additively manufactured, without using geometries, in particular prisms, which place high requirements on downstream reworking.

In particular, via the solution described, such light guides 1 are easily and cost-effectively produced via the additive manufacture. This would otherwise only be possible with significant technical manufacturing complexity.

By the solution described, a further problem of additively manufactured light guides 1 is additionally solved. Such light guides 1 emit light L over their lateral surface due to a sometimes high level of volume dispersal. This occurs more significantly and less evenly than in light guides which have been injection molded in a conventional manner. The emission, in particular, runs exponentially along the longitudinal direction. The solution described here can also solve this problem, and effect a homogeneous emission.

As already specified, the light guide 1 described here functions fundamentally based on the principle of total internal reflection. Sufficiently flat surfaces must be present to fulfil this principle. If these surfaces are not generated with the manufacturing method used, reworking methods can be used that allow the surface to be smoothed such that total internal reflection takes place, as shown in FIG. 5. Such reworking is mostly required when implementing additively manufactured light guides 1. This is used for the solution described in the following.

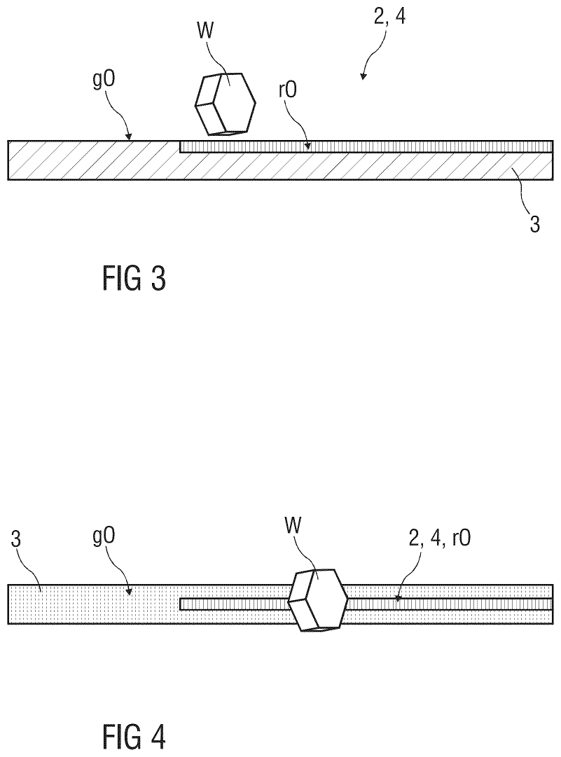

In the method for producing the light guide 1, it is thus provided that a blank 3 of the light guide 1, depicted in an exemplary form in FIGS. 1 to 4, is generated by additive manufacturing, for example by photopolymer jetting, by stereo lithography, or by a light projection method, in particular DLP (Digital Light Processing), and the blank 3 is then reworked with at least one machining tool W, as shown in an exemplary and schematically significantly simplified manner in FIGS. 3 and 4.

Directly after the actual additive manufacturing step, the blank 3 has a surface that is so rough that the light L is here diffusely dispersed, and consequently does not remain in the light guide 1. On machined surfaces, however, which are sufficiently smooth, no or significantly less diffuse dispersal takes place, and instead the light L is specular-reflected, because the condition for total internal reflection, i.e., the critical angle of total internal reflection, can be maintained by a sufficiently smooth surface.

Accordingly, reworked points of the light guide 1 thus have a smooth surface, specifically a surface gO smoothed by reworking, and no light L is decoupled, while non-reworked points of the light guide L retain a rough surface rO, specifically the rough surface rO formed by the additive manufacturing of the blank 3, at which the light L can be decoupled from the light guide 1 by diffuse dispersal.

In the method for producing the light guide 1, it is thus provided that the blank 3 is exclusively reworked in at least one region that is not provided as a light decoupling point 2. This region extends, in particular, over an entire surface of the blank 3, in particular at least over an entire peripheral surface, i.e., lateral surface, of the blank 3, with the exception of a surface of the at least one or respective light decoupling point 2. In other words, the blank 3 is reworked everywhere where no light decoupling point 2 is provided, and the blank 3 is not reworked where a light decoupling point 2 or a respective light decoupling point 2 is provided.

In order to make this possible particularly easily and safely, as shown in FIGS. 1 to 20, a recess 4 is generated by the additive manufacture of the blank 3 on at least one predetermined portion of the blank 3, on which the at least one light decoupling point 2 of the light guide 1 is provided, or on the respective predetermined portion of the blank 3 on which the respective light decoupling point 2 of the light guide 1 is provided, such that, and at least one machining tool W is used to rework the blank 3, the machining tool being designed such that at least one surface portion of the blank 3 in the recess 4 cannot be reached with the at least one machining tool W used to rework the blank 3.

For example, the recess 4 is generated by the additive manufacture of the blank 3 on the at least one predetermined portion of the blank 3, on which the at least one light decoupling point 2 of the light guide 1 is provided, or on the respective predetermined portion of the blank 3 on which the respective light decoupling point 2 of the light guide 1 is provided, and at least one machining tool W is, for example, used to rework the blank 3, the tool being designed such that an opening of the at least one recess 4 is smaller than a size of the at least one machining tool W used to rework the blank 3, in particular such that a length and/or a width and/or a diameter and/or a clear width of the opening of the recess 4 is smaller than a length and/or a width and/or a diameter and/or a surface area of the at least one machining tool W used to rework the blank 3, and/or such that a depth of the at least one recess 4 is greater than a height of the at least one machining tool W used to rework the blank 3.

The surface, generated exclusively via additive manufacturing, of the at least one provided light decoupling point 2 or of the respectively provided light decoupling point 2 of the light guide 1 is thus located in the recess 4 generated by the additive manufacturing.

The solution described thus makes it particularly easily possible to rework the blank 3 exclusively in the region that is not provided as a light decoupling point 2, because it is ensured by the design of the recess 4 and the tool W used for reworking that the surface of the blank 3 cannot be reworked in the at least one or respective region provided as a light decoupling point 2 by means of the tool W used. No additional safety measures must thus be taken for the reworking in order to ensure that the surface of the blank 3 is not reworked on the provided at least one or respective light decoupling point 2. The described solution thus, in particular, makes it possible to generate local roughness differences on the surface of the additively generated light guide 1 via the limitation of the reworking achieved via one or more predetermined geometric shapings of the blank 3 in the form of recesses 4.

In a possible embodiment of the method, the blank 3 is reworked via grinding, in particular vibration grinding and/or polishing, as schematically indicated in a significantly simplified manner in FIGS. 3 and 4. The at least one machining tool W used for this reworking is thus designed as at least one grinding body and/or polishing body, or comprises at least one such grinding body and/or polishing body.

The at least one reworked region is thus reworked on the light guide 1 according to the invention via grinding and/or polishing.

In such reworking methods, for example vibration grinding, smoothing is achieved via a relative movement between the tool W, in particular the grinding body and/or polishing body, and the workpiece, here the blank 3 of the light guide 1. In the method described here, in the manner described above, only the region of the surface of the workpiece geometry of the blank 3 is smoothed on which the tool W, in particular the grinding body and/or polishing body, can also correspondingly slide or slide past, i.e., along which the grinding body and/or polishing body can slide. As this is impossible at the provided at least one or respective light decoupling point 2 in the manner described above, the surface of the blank 3 of the light guide 1 is thus not reworked there.

The technical solution thus advantageously consists in that the additively manufactured blank 3 of the light guide 1 has a geometry leading the at least one tool W used for reworking, for example the grinding body and/or polishing body, to be unable to act, or to be able to act only under certain conditions, at at least one predetermined point, specifically the at least one provided light decoupling point 2, or at several such points on the surface of the blank 3 of the light guide 1, while the blank 3 is being reworked, and thus allows the light decoupling along the light guide 1 to be able to be adjusted in a targeted manner via the geometry and the local variation specified above of the roughness of the surface that was generated by the additive manufacturing.

The at least one or the respective recess 4 can, for example, be designed as a blind hole, groove, incision, or other recess 4. As already specified, the recess is generated by the additive manufacture of the blank 3. In FIGS. 1 to 20, different forms of recesses 4 are depicted in an exemplary manner.

The recess 4 is designed in FIGS. 1 to 6 as a groove running in the longitudinal direction, having a width and depth which remain the same, which ends in the region of an end face of the light guide 1.

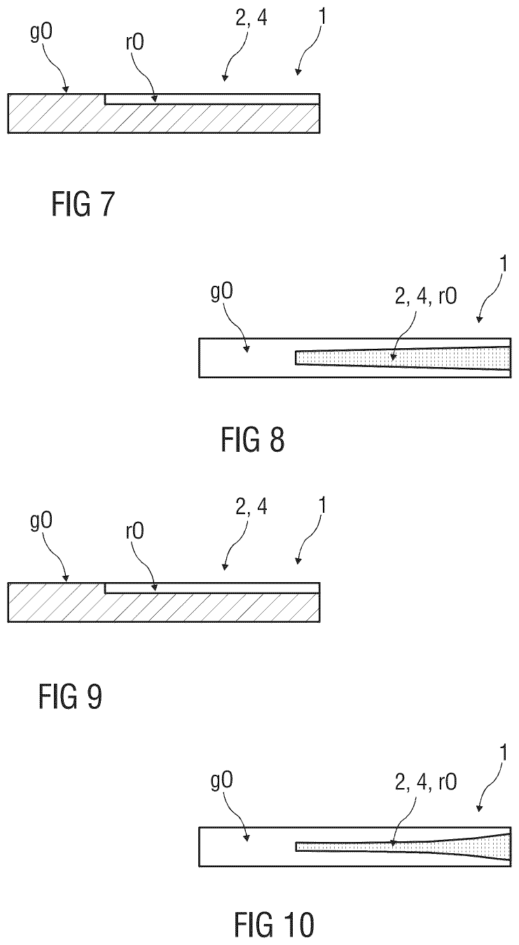

The recess 4 is designed in FIGS. 7 and 8 as a groove running in the longitudinal direction, having a depth that remains the same and a width that increases evenly and ends in the region of an end face of the light guide 1. The surface of the light decoupling point 2 thus enlarges increasingly in the direction of this end face.

The recess 4 is designed in FIGS. 9 and 10 as a groove running in the longitudinal direction, having a depth which remains the same and a width which increases increasingly more significantly, which ends in the region of an end face of the light guide 1. The surface of the light decoupling point 2 thus enlarges increasingly in the direction of this end face.

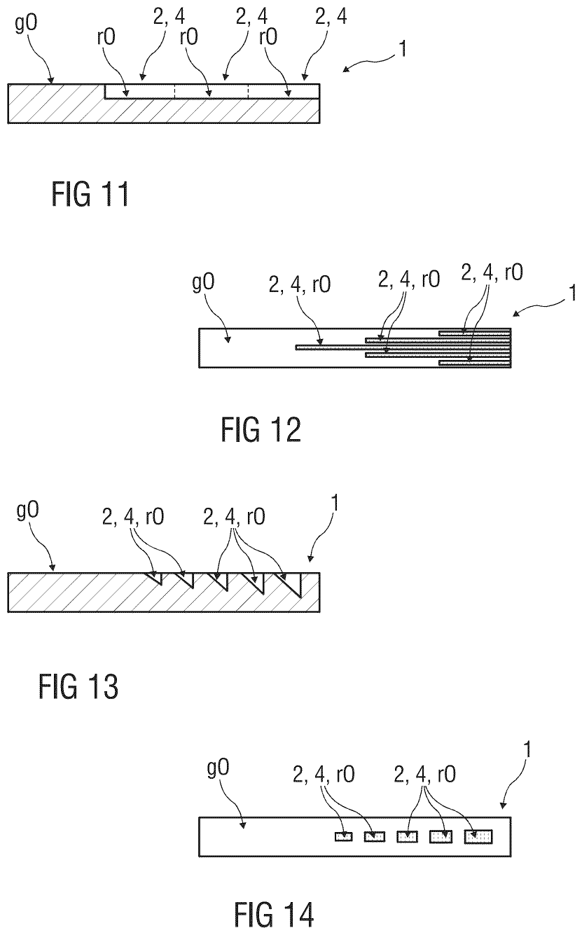

In FIGS. 11 and 12, several recesses 4, here five recesses 4, are provided, which are arranged next to each other in the transverse direction, and which are respectively designed as a long, thin groove running in the longitudinal direction, having a width and depth which remain the same, which ends in the region of an end face of the light guide 1, wherein the central recess 4 is the longest, and the length of the recesses 4 decreases outwardly in the transverse direction, i.e., the other recesses 4 are shortest. These grooves are in particular respectively designed as long, thin slits.

In FIGS. 13 and 14, several recesses 4, here five recesses 4, are respectively designed in the shape of saw teeth, i.e., having an oblique base surface, which is tilted in the longitudinal direction of the light guide 1. The recesses 4 are arranged one behind the other in the longitudinal direction of the light guide 1 and have different lengths, widths, and depths, wherein the length, width, and depth of the recess 4 arranged in the central region of the light guide 1 is the smallest and increases further for the recess 4 respectively following in the direction of the end face of the light guide 1. The respective recess 4 is deepest in the direction of the right end face of the light guide 1. A gradual change of width and depth of the recesses 4, and thus of the light decoupling points 2, in particular of their effective light decoupling surfaces is thus present.

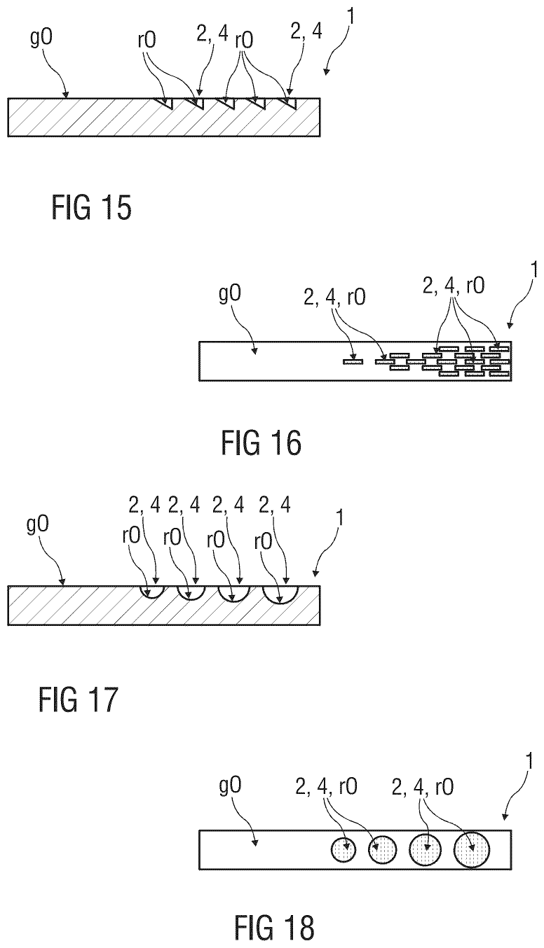

In FIGS. 15 and 16, several such saw tooth-shaped recesses 4 are also provided, which are all designed in the same way here, however, and are arranged offset from each other in the longitudinal direction and in the transverse direction. The number of recesses 4 increases in the direction of the one end face of the light guide 1, such that a gradual increase in the number of light decoupling points 2, and in particular of their effective light decoupling surfaces in the direction of this end face of the light guide 1 is achieved.

In FIGS. 17 and 18, several, here four, semi-spherical recesses 4 are provided, wherein the recess 4 arranged in the central region of the light guide 1 is smallest and the size of the recesses 4 increases in the direction of the end face of the light guide 1. The radius of the semi-spheres, and also a surface area of the respective light decoupling point 2 thus also increase.

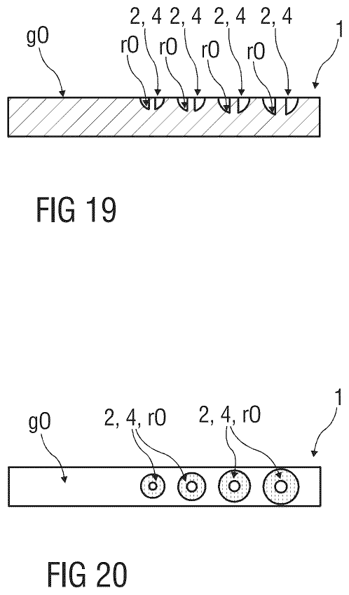

In FIGS. 19 and 20, several, here four, annular recesses 4 are designed, wherein a depth and an annular opening width of the recess 4 is smallest in the central region of the light guide 1 and increases in the direction of the end face of the light guide 1, and is thus largest for the recess 4 on the end face. The depth of the respective recess 4 is lowest on the outer ring edge, and greatest on the inner ring edge. A diameter of one of the central columns forming the respective inner ring edge is also smallest for the recess 4 arranged in the central region of the light guide 1, and increases in the direction of the end face of the light guide 1 and is thus largest for the recess 4 on the end face. The surface of this central column of the respective recess 4 is also reworked, and thus smoothed, i.e., these bolts also have the smoothed surface gO. The central columns in particular enable a smaller tool W to be used for the reworking, in particular a smaller grinding body and/or polishing body. Via the respective central column, a penetration of such a small tool W into the respective recess 4 is also prevented.

The opening of the at least one or respective recess 4 is advantageously smaller than the at least one tool W used for the reworking, in particular the grinding body and/or polishing body. The surface of the blank 3 at the respective point, which is provided as a light decoupling point 2, is not reworked, while advantageously the remaining surface of the blank 3 is reworked, in particular ground smooth and/or polished. The rough part of the surface, i.e., the rough surface rO, then serves as a decoupling structure, and thus forms the light decoupling point 2 of the light guide 1, and total internal reflection takes place on the remaining surface of the light guide 1, i.e., on the smoothed surface gO.

Due to the additive manufacturing of the blank 3, the recess 4 or the respective recess is for example generated with constant dimensions, as shown in FIGS. 1 to 6 and 11 and 12, or with at least one dimension which changes over the course of the recess, as shown in FIGS. 7 to 10 and 13 to 20, for example with a changing depth and/or width and/or with a changing diameter and/or a changing clear width. The course of the recess can be aligned in the length direction and/or width direction and/or depth direction and/or peripheral direction of the blank 3, and thus also of the light guide 1.

On the light guide 1, the recess 4 or the respective recess 4 correspondingly has constant dimensions, for example, or at least one dimension which changes over the recess course.

To form a structure of the respective recess 4 and a structure of the respective light decoupling point 2, many variants are possible; in addition to simple, straight recesses 4, many further geometries are also considered, as shown in an exemplary form in FIGS. 1 to 20.

The decoupling structure generated in this manner of the light decoupling point 2 or several light decoupling points 2 can in particular be designed in a graduated manner without further complexity. For example, an undesired, uneven emission of the light guide 1, which is already present due to volume dispersal or the like without a decoupling structure, can be homogenized in this manner via a gradient that is inverse to this uneven emission, as shown in the examples according to FIGS. 7 to 20. Here, a surface area of the one light decoupling point 2 or a shared surface area of the several light decoupling points 2 increases constantly in the direction of the one end face, here the right end face of the light guide 1. The light is advantageously coupled into the light guide 1 via the other, here the left, end face of the light guide 1.

As an alternative or in addition to homogenization, a graduated decoupling structure can also be used to generate a predetermined brightness course, for example in order to particularly showcase predetermined regions of the component designed as a decorative part and comprising the light guide 1. The graduated design of the light decoupling point 2 or several light decoupling points 2 is, in particular, achieved by a corresponding design of the recess 4 or of several recesses 4, in particular in the manner described above by the at least one dimension which varies over the course of the recess or several or all dimensions of the recess 4 which vary over the course of the recess, and/or by several recesses 4 with dimensions which differ from one another.

By additive manufacturing, it is, in particular, additionally possible to also orientate the surface of the blank 3 in a predetermined manner, i.e., to align it in a predetermined manner, in particular deviating from a surrounding surface, in particular reworked surface of the light guide 1, at the at least one or respective light decoupling point 2, i.e., in the region which is not reworked, and in which light L is thus decoupled due to the maintained roughness produced by the additive manufacturing. A direction of the decoupled light L can thus also be adjusted, in particular if the roughness is such that specular components are also present in addition to a diffuse light decoupling. Examples of the latter are the saw tooth-shaped recesses 4 in FIGS. 13 to 16. Here, for example, the light L is decoupled obliquely, here obliquely in the direction of the one, here the right, end face of the light guide 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for producing a light guide, the method comprising:
generating a blank of the light guide with a recess by additive manufacture; and
reworking the blank with at least one machining tool,
wherein the blank is exclusively reworked in at least one region of that blank that is not provided as a light decoupling point, and
wherein the recess is generated on at least one predetermined portion of the blank such that the at least one machining tool is configured such that at least one surface portion of the blank in the recess cannot be reached with the at least one machining tool.

8. The method of claim 7, wherein the recess is generated by the additive manufacture such that
the at least one machining tool is configured such that a length, a width, a diameter, or a clear width of an opening of the recess is respectively smaller than a length, a width, a diameter, or a surface area of the at least one machining tool, or
a depth of the at least one recess is greater than a height of the at least one machining tool.

9. The method of claim 7, wherein the additive manufacture of the blank, generates the recess with constant dimensions or with at least one dimension that changes over a course of the recess.

10. The method of claim 7, wherein the reworking is grinding or polishing.
